(19) United States
(12) Patent Application Publication
(10) Pub. No.: US 2024/0372795 A1
(43) Pub. Date: Nov. 7, 2024

(54) SYSTEMS AND METHODS FOR IMPROVED CAMERA SECURITY

(71) Applicant: CenturyLink Intellectual Property LLC, Denver, CO (US)

(72) Inventors: Dean Ballew, Sterling, VA (US); John R.B. Woodworth, Amissville, VA (US)

(73) Assignee: CenturyLink Intellectual Property LLC, Denver, CO (US)

(21) Appl. No.: 18/630,619

(22) Filed: Apr. 9, 2024

Related U.S. Application Data
(60) Provisional application No. 63/499,587, filed on May 2, 2023.

(51) Int. Cl. H04L 43/0894; H04L 9/40; H04N 7/18

(52) U.S. Cl. CPC H04L 43/0894; H04L 63/1425; H04N 7/18

(57) ABSTRACT

Video cameras are present in a wide variety of electronic devices. Such video cameras may present an opportunity for unauthorized video surveillance, for example, by a malicious actor who may attack, compromise, and commandeer such a camera. As such, systems and methods for improved camera security are provided.

### CROSS-REFERENCE TO RELATED APPLICATIONS

This application claims the benefit of U.S. Provisional Application No. 63/499,587 filed 2 May 2023, entitled “Systems and Methods for Improved Camera Security,” which is incorporated herein by reference in its entirety.

### FIELD

One or more aspects of examples according to the present disclosure relate to network-connected video cameras, and more particularly to systems and methods for improved camera security.

### BACKGROUND

Video cameras are present in a wide variety of electronic devices. Such video cameras may present an opportunity for unauthorized video surveillance, for example, by a malicious actor who may attack, compromise, and commandeer such a camera.

It is with respect to this general technical environment that aspects of the present disclosure are related.

### SUMMARY

Systems and methods for improved camera security are provided. In an aspect, a system includes a first projector and a network traffic analyzer. The first projector may be configured to form a first pattern within a field of view of a first video camera, and the network traffic analyzer may be configured to monitor network traffic in a first network connection, and to determine, based on a data rate of the network traffic, whether video data including images of the first pattern are included in the network traffic.

In examples, the first pattern has a duration of at least one second.

In examples, the first pattern is compression resistant.

In examples, the first projector is configured to cause a first video data rate of the first video camera to be modulated according to a modulation of the first pattern. In such examples, the network traffic analyzer may be configured to determine whether the data rate of the network traffic in the first network connection correlates to the modulation.

In examples, the first network connection is a network connection on a wide-area-network side of a router for a facility.

In examples, the first network connection is a network connection on a local-area-network side of a router for a facility. In such examples, the network traffic analyzer may be further configured to monitor network traffic in a second network connection, and to determine whether video data including images of the first pattern is included in the network traffic of the second network connection. In such examples, the second network connection may be a network connection on a wide-area-network side of the router.

In examples, the network traffic analyzer comprises a transparent bridge, and the first network connection is a connection to the transparent bridge.

In examples, the first projector comprises an interface for receiving an activation instruction, and the first projector is configured to transmit the first pattern upon receiving the activation instruction.

In examples, the first projector is configured to transmit the first pattern upon receiving an instruction from the network traffic analyzer.

In examples, the system comprises a second projector. In such examples, the second projector may be configured to form a second pattern within a field of view of a second video camera. In such examples, the first pattern may include a change at a first point in time; and the second pattern may include a change at a second point in time, different from the first point in time. In such examples, the network traffic analyzer may be configured: to detect a change, at a third point in time, in the data rate of the network traffic; and to determine: that the third point in time correlates to the first point in time, and that the change in the data rate corresponds to the change in the first pattern.

In another aspect, a camera detection system is provided, comprising a projector and a network traffic analyzer. The camera detection system may be configured to detect the presence of an active camera on a network, by: causing a modification of a scene observed by the camera, and detecting a change corresponding to the modification in an outgoing data rate of network data.

In another aspect, a method is provided comprising: causing a projector to form a pattern detectable by a video camera; and analyzing a network data rate for network traffic to determine whether the network data rate indicates that the network traffic includes images of the pattern.

In examples, the pattern is compression resistant. In addition, in examples, the pattern changes at a first point in time, and the determining whether the network data rate indicates that the network traffic includes images of the pattern comprises determining whether the network traffic exhibits a corresponding change in the data rate at the first point in time.

### BRIEF DESCRIPTION OF THE DRAWINGS

These and other features and advantages of the present disclosure will be appreciated and understood with reference to the specification, claims, and appended drawings wherein:

FIG. 1A is a block diagram of a system for improved camera security, according to an example of the present disclosure;

FIG. 1B is a block diagram of a system for improved camera security, according to an example of the present disclosure;

FIG. 2 is a flow chart, according to an example of the present disclosure; and

FIG. 3 is a block diagram of an operating environment, according to an example of the present disclosure.

### DETAILED DESCRIPTION

The detailed description set forth below in connection with the appended drawings is intended as a description of exemplary embodiments of systems and methods for improved camera security provided in accordance with the present disclosure and is not intended to represent the only forms in which the present disclosure may be constructed or utilized. The description sets forth the features of the present disclosure in connection with the illustrated examples. It is to be understood, however, that the same or equivalent functions and structures may be accomplished by different examples that are also intended to be encompassed within the scope of the disclosure. As denoted elsewhere herein, like element numbers are intended to indicate like elements or features.

Video cameras are present in a large variety of electronic devices, including mobile telephones, laptop computers, computer monitors, television sets, and parental monitoring cameras, or “nanny cams”. Such cameras may be present for the purpose of, for example, enabling a display device (such as a computer monitor or a television set) to be used for video conferencing, gaming, etc. A camera in such an electronic device may include an encoder for encoding the raw video data from the sensor chip in the camera to a compressed video stream. The device may be configured to transmit the compressed video stream, e.g., to a server on the internet, from which it may be transmitted to other devices (e.g., to the computer monitor of another participant in a video conference, or to the mobile phone of a parent watching a nanny cam).

In some circumstances, such cameras may also be used, however, for unauthorized surveillance by a malicious actor. For example, an internet-enabled television set in a home may be attacked and compromised by a malicious actor, who may take control of the camera in the television set and cause the camera to stream video of the interior of the home, e.g., to a server controlled by the malicious actor. Unauthorized surveillance may also occur if a malicious actor places an unauthorized video camera in a facility and connects it to the facility's local area network. As used herein, a “facility” is any space in which systems and methods for improved camera security may be used, including, for example, a home (e.g., a house or an apartment), an industrial facility (e.g., a factory), a clinic (e.g., dentist's or doctor's office), or an office (e.g., the office of an accounting firm).

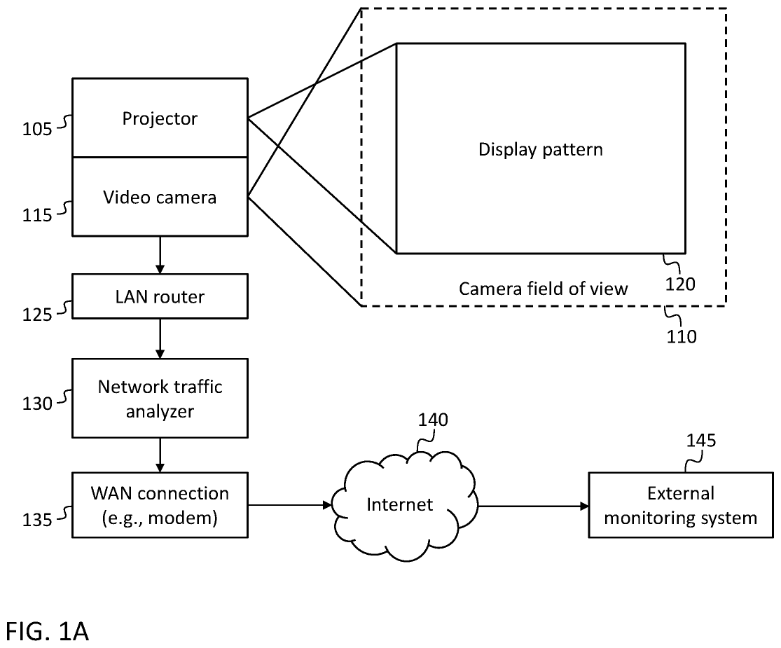

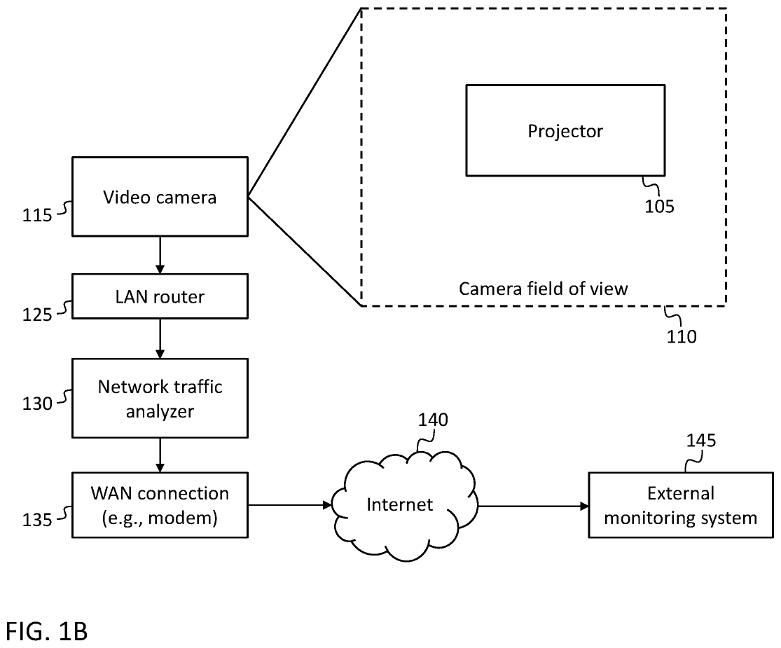

In some examples, therefore, a system for improved camera security includes, as shown in FIG. 1A, a projector 105 configured to form, within the field of view 110 of such a video camera 115, a pattern 120 (which may be referred to as a “display pattern”) that when captured by the camera and transmitted out of the facility causes an increase in the activity of a network connection that video data from the camera flows through. The system further includes a network traffic analyzer 130 for detecting such an increase in activity. If the system detects the unauthorized transmission of video data from the facility, it may take remedial action to mitigate the unauthorized transmission.

The display pattern 120 may, for example, be a pattern of light projected onto a wall that is in the field of view of, e.g., a video camera that is known to the facility operator. Or the display pattern may be projected into an area that a facility operator may wish to protect from unauthorized video. For example, the area may be one in which a video camera is not legitimately placed. The display pattern may be formed using infrared light (e.g., by a scanned, modulated infrared laser, or by one or more light-emitting diodes) so as not to be distracting to users in the facility. In other examples, the display pattern may be formed directly in the field of view of the video camera (e.g., by an array of LEDs that is in the field of view of the video camera), as shown in FIG. 1B, instead of being reflected from a surface (e.g., from a wall in the field of view of the video camera).

The display pattern may vary with time, e.g., it may include (e.g., consist of) various patterns (which may be referred to as “sub-patterns”) projected in a sequence, and portions of the display pattern may be selected to be compression resistant (e.g., poorly compressible), so that when the display pattern is displayed, the transmitted data rate from the video camera may increase significantly. In examples, because video compression algorithms generally seek to transmit only information indicative of a delta change in a captured video scene, projecting a pattern that includes significant changes may cause a significant increase in the data rate of the compressed video transmitted from the camera. As used herein, and in different examples, a display pattern is “compression resistant” if the presence of the display pattern in a camera field of view increases the compressed video data rate by an average of at least 5%, or at least 10%, or at least 20%, or at least 30%, at least 50%, or at least 100% versus the compressed video data rate of the same camera field of view without the display pattern. In examples, the increase in the compressed video data rate may be measured based on capturing video of a camera field of view that is not changing other than the display pattern.

In some examples, for example, the pattern changes significantly with time (e.g., changing with a frequency between once per second and 60 times for per second), as an obstacle to efficient compression by an encoder that uses frame-to-frame similarities in the raw video stream to compress the video data. In some examples, for example, the pattern may include a sequence of sub-patterns, each including a pseudorandom set of dark and bright regions (e.g., squares) the pattern advancing to the next sub-pattern, e.g., once every 3 to 5 frames (of video captured by the video camera; e.g., every 1/20 of a second or every 1/12 of a second, if the video camera is expected to operate at 60 Hz). The rate at which the sub-patterns are changed may be selected to avoid or reduce blurring and also to be sufficiently high to cause a measurable increase in data rate in the network connection being monitored by the network traffic analyzer 130. Blurring may occur if the sub-pattern is changed during the exposure for a frame of video or if the process of changing from one sub-pattern to the next (which may not be instantaneous, e.g., if the projector 105 uses a laser scanner) extends over multiple frames of video.

The display pattern may further vary with time, e.g., according to a modulation, in a manner that causes the compressed video data rate to vary, e.g., to be modulated. For example, the modulation may be on-off modulation, in which some of the time (during “on” intervals of the modulation) the sub-patterns (and the corresponding increase in the compressed video data rate) are present, and in which some of the time (during the “off” intervals of the modulation) the sub-patterns (and the corresponding increase in the compressed video data rate) are absent. As another example, the modulation may consist of causing the display pattern to alternate between (i) sequences of sub-patterns (e.g., rapidly changing complex sub-patterns each including many dark and bright regions) that result in a high compressed video data rate and (ii) sequences of sub-patterns (e.g., simple, rarely changing patterns with few dark and bright regions) that do not contribute significantly to the compressed video data rate.

The video camera 115 (or the electronic device, such as a television set or gaming console, containing the video camera 115) may send the compressed video stream to a local area network router (LAN router) 125, which may then send the compressed video stream to the internet 140 (e.g., to a server on the internet 140) via a wide area network (WAN) connection point 135 (e.g., a modem connected to an internet service provider). The network traffic analyzer 130 may be connected between the LAN router 125 and the WAN connection point 135. The network traffic analyzer 130 may be configured to operate as a transparent bridge, transmitting network traffic unchanged while monitoring the network traffic. The network traffic analyzer 130 may be integrated with (e.g., in a shared enclosure with) the LAN router 125, or with both the LAN router 125 and the WAN connection point 135. Such a configuration may make it feasible for the network traffic analyzer 130 to monitor traffic between the LAN router 125 and the WAN connection point 135 even if the LAN router 125 is integrated with the WAN connection point 135. In other examples, the network traffic analyzer 130 may be implemented as a separate device, and the LAN router 125 and/or WAN connection point 135 may be configured to provide the compressed video stream (or sample packets therefrom) to the network traffic analyzer 130 separately.

In examples, the network traffic analyzer 130 may communicate with the projector 105, so that the network traffic analyzer 130 is aware of the changes in data rate that may be expected at any time if a video camera in the facility is capturing and transmitting the display pattern 120. For example, the projector 105 may inform the network traffic analyzer 130 of the display pattern 120 being transmitted by any particular projector 105, or the network traffic analyzer 130 may send instructions to the projector 105, indicating when the display pattern 120 should significantly increase the data rate of any camera capturing the pattern and when it should not. In some examples, multiple projectors 105 are present in a facility (e.g., one projector 105 may be present in each room of the facility).

In operation, the network traffic analyzer 130 may test the network connection to which it is connected (e.g., in FIGS. 1A and 1B, the network connection between the LAN router 125 and the WAN connection point 135) for an indication of the presence of video data containing the display pattern 120, e.g., by calculating a correlation between (i) the data rate contribution, as a function of time, that is expected to be included in the total data rate if video data containing the display pattern 120 is transmitted through the network connection and (ii) the rate at which data is transmitted through the network connection. A relatively high correlation may indicate that a video camera is currently active and capturing video containing the display pattern 120, and transmitting the video data through the network connection. This may permit a determination that the video camera is currently active and capturing video containing the display pattern 120 without requiring the network traffic analyzer 130 to analyze the video data itself. Rather, with considerably less processing overhead required compared to video analysis, the determination may be made by monitoring data rates for network traffic being transceived at a network connection.

The network connection monitored by the network traffic analyzer 130 may be a connection for the entire facility (e.g., as illustrated in FIGS. 1A and 1B) or it may be, e.g., a connection to a single camera-containing device (e.g., the connection between the video camera 115 and the LAN router 125), if a dedicated connection (e.g., a wired Ethernet connection) is used for this purpose. In some examples the network traffic analyzer 130 is connected to, and monitors, a plurality of network connections (e.g., each wired Ethernet port of the LAN side of the LAN router 125 and the wired Ethernet port on the WAN side of the LAN router 125), or multiple network traffic analyzers 130, configured to communicate with each other and with each of the projectors 105) may be present in the facility and may monitor a plurality of network connections. In a system in which some of the network connections are wireless connections, the network traffic analyzer 130 may only have access to aggregated data and not analyze wireless data directly or separately. In some examples, the network traffic analyzer 130 analyzer may have wireless connectivity as well and may have awareness of certain wireless configuration details.

If an active video camera is detected that appears to be capturing the projected pattern, the network traffic analyzer 130 may be able to infer where in the facility the video camera is (i) from the location of a currently active projector 105 (e.g., the network traffic analyzer 130 may determine that the video camera is in the same room as the projector 105) or (ii) from the network connection monitored by the network traffic analyzer 130 (e.g., if the network connection is on the LAN side of the LAN router 125 and only one video camera in the facility is connected to this network connection).

In some examples, the network traffic analyzer 130 monitors the aggregate network traffic in the network connection to which it is connected. In such examples, the modulation of the projected pattern should be configured to be detectable even within the aggregate network traffic (including traffic from other sources on the network). In other examples, the network traffic analyzer 130 may monitor the network traffic per source Internet Protocol (IP) address. In some examples, the network traffic analyzer 130 monitors the aggregate network traffic until it detects indications that a camera is active (and capturing video of the display pattern produced by the projector 105), and the network traffic analyzer 130 then begins to monitor the network traffic by source IP address. Monitoring of the traffic by source IP address may enable the network traffic analyzer 130 to identify the IP address of the camera that is capturing video of the display pattern produced by the projector 105. Once the IP address of the camera is known, it may be possible to identify the physical device containing the camera, e.g., based on a Network Address Translation (NAT) table, or if a Network Monitoring System (NMS) is present, based on data maintained by the NMS. Constructing a NAT table may be performed based on identifying streams (with consistent source/IP address/port destination/IP address/port tuples). Such an approach may have limited visibility into the inside devices. In examples in which the network traffic analyzer 130 is integrated into the LAN router 125, however, the network traffic analyzer 130 may gain that additional visibility.

In some examples, when the network traffic analyzer 130 determines that a video camera is currently active and capturing a projected pattern, it may inform a user (e.g., a member of the security staff, or an automated security system) of this determination (e.g., sending a message, e.g., via short message service (SMS) or email, such as “A video camera is currently recording in room 205”, if the projector is in room 205 of the facility). The user may then assess whether this is expected (e.g., caused by a video camera the user knows to be in operation) and, if not, take suitable remedial action.

In some examples, the projector 105 is activated only when it is expected that no authorized video cameras are currently active in the area of the projector 105 (e.g., cameras with a field of view where the projected pattern would be detectable). In such a situation, if the network traffic analyzer 130 detects an active video camera capturing the projected pattern, remedial action may be taken directly. For example, the network traffic analyzer 130 may then (i) shut off all outbound traffic from the facility (e.g., cause WAN connection 135 to cease transmitting), or (ii) notify one or more users with a suitable (SMS or email) message, or (iii) sound an alarm (e.g., an audible alarm), or (iv) instruct the projector 105 to sound an alarm (e.g., an audible alarm).

The determination of whether any video cameras are expected to be active in a particular area may be made in several ways. First, as discussed, in some examples, a projector 105 is placed in an area where video of that area should never be legitimately captured. In such examples, the detection of network traffic correlating to modulation of the pattern projected by such projector 105 may always be considered illegitimate, as it may be indicative of an unauthorized camera having been placed in the area. In other examples, the network traffic analyzer 130 may be in communication with a first device (e.g., a computer connected to a monitor including a camera or a separate camera) and the network traffic analyzer 130 may query the first device (e.g., the computer) whether the video camera in another device (e.g., the monitor or the separate, connected camera) should be active. As another example, the facility may implement a policy that no cameras should be active unless their activation has previously been authorized by a user (who may give such authorization after supplying suitable credentials to the network traffic analyzer 130, e.g., via a browser-accessible interface hosted by the network traffic analyzer 130). As another example, a user, who believes that no cameras should be active in a certain room of the facility, may send (using a suitable user interface) an activation instruction to the system (e.g., by pressing a button provided for that purpose on a projector 105 in the room), instructing it to check for active cameras, and, in response, the projector 105 may begin to transmit the display pattern.

In some examples where the projector 105 is placed proximate to a known video camera 115, the projector 105 may receive usage data from video camera 115 (and/or the machine of which the video camera 115 forms a part or to which it is connected, such as a gaming console) indicating whether the video camera 115 should be on. For example, the gaming console may provide an indication whether it is currently in standby mode (not in active gaming mode) indicating that the camera 115 should not be on. If such an indicator is received (indicating that the camera should not be on), the projector 105 may be turned on. In other examples, the projector 105 is always projecting the pattern to avoid spoofing of signals of legitimacy from the video camera 115 to the projector 105.

If an unauthorized video camera is present in the facility, then this camera becoming active may not be detected by the network traffic analyzer 130 if the network traffic analyzer 130 is only connected to, e.g., wired Ethernet connections for devices known to contain video cameras. The activity of such an unauthorized video camera may however be detected if: (a) the unauthorized video camera is connected (e.g., wirelessly) to the LAN router 125; and (b) (for example, as illustrated in FIGS. 1A and 1B) the network traffic analyzer 130 is connected to, and monitors, a network connection used by all outbound traffic from the facility (e.g., operating between the LAN router 125 and WAN connection 135).

In a facility with a plurality of projectors 105 (with, e.g., one projector 105 in each room), the projectors 105 may be turned on one at a time or in changing groups (e.g., under the control of the network traffic analyzer 130). As a result, it may be possible to infer the approximate location of any active video camera detected based on the location of the projector 105 that was active when the active video camera was detected. For example, the network traffic analyzer 130 may receive location data for each projector 105 (and one or more corresponding camera 115, if any) when the projector is installed (e.g., via a user interface). In addition, each projector 105 may be assigned a unique identifier. As such, if the projectors 105 are turned on one at a time or in groups, e.g., in rotating fashion, when the traffic analyzer 130 detects data rate modulation indicative of an active camera capturing a projected pattern, the relevant projector 105 (and corresponding camera 115) can be determined from the time of the data rate modulation, and the location of the projector 105 (and corresponding camera 115) can then be determined from the stored location information.

In another example, each projector 105 may produce a respective data rate modulation in the compressed video data rate of any video camera viewing the output of the projector 105. In such an example the respective data rate modulations may be selected to be independent (e.g., orthogonal). When such independent modulations are employed, the display pattern produced by a first projector 105 may change at a first point in time, and the display pattern produced by a second projector 105 may change at a second point in time, different from the first point in time. As used herein, a “point in time” may comprise a period of time so as to evaluate a data-rate pattern or change rather than a discrete point. The network traffic analyzer 130 may then detect a change, e.g., at a third point in time (which may correlate to the first point in time), in a data rate in the network connection monitored by the network traffic analyzer 130, and infer that the change in the data rate corresponds to the change in the display pattern produced by the first projector 105. In examples, the third point in time may correlate to the first point in time if: (a) the first point in time is substantially the same as the third point in time; (b) the third point in time follows the first point in time by a known propagation and processing delay; (c) the third point in time is substantially the same as the first point in time plus a known period at which the first pattern repeats. Other methods for correlating the third point in time to the first point in time are possible and contemplated to effectively determine that the change (e.g., recognizable modulation) of the data rate observed at the network traffic analyzer 130 was likely caused by an active camera 115 capturing the display pattern from the first projector 105. Again, stored location data can then be used to determine the location of the relevant projector 105 and, potentially, corresponding camera(s) 115.

In another example, the network traffic analyzer 130 may calculate a plurality of correlations (each corresponding to a respective modulation of the independent modulations) with the data rate observed in the network connection it is monitoring, and the network traffic analyzer 130 may determine (e.g., from the highest correlation) which projector 105 is causing changes in the total data rate and is therefore the projector 105 the display pattern of which is being captured by an active video camera. Similarly, if several projectors 105 are concurrently causing changes in the total data rate, the network traffic analyzer 130 may infer, from the corresponding correlations, that the display patterns of all of the several projectors 105 are being captured (e.g., by several respective video cameras 115).

In some examples, the setting up of a projector 105 may take place when a device containing a video camera is first connected to the facility's network or when a projector 105 without a corresponding, authorized camera is installed. In the latter case, a video camera 115 may be temporarily connected to gauge the effect of the projector 105 on data rate analysis. For example, upon installation, an operator may instruct the projector 105 and the network traffic analyzer 130 to perform a setup operation. In such an operation, the network traffic analyzer 130 and the projector 105 may cooperate to test a plurality of display patterns to determine which pattern, projected where, produces the greatest (and most distinctive) effect on the compressed video data rate produced by the video camera. This testing may, for example, use a gradient descent method (or a coarse sweep followed by further adjustment using gradient descent) over parameters such as the sizes of the bright and dark regions, the overall size of the display pattern 120, the position of the center of the display pattern 120, and the rate at which the sub-patterns are changed. In some examples, artificial intelligence or machine learning may be employed to find the values of such parameters.

In some examples, the projector 105 is integrated with the camera 115 (e.g., it is in the same enclosure or device as the device that includes the video camera). In some examples, an external monitoring system 145, which may run on a server connected to the internet, may receive reports of network activity from the network traffic analyzer 130, and participate (i) in determining whether unauthorized surveillance is occurring in the facility and (ii) in taking suitable remedial action if it is. In some examples, the projector 105 is not a source of light but instead modulates light reflected from it or transmitted through it to form the display pattern 120. For example, the projector 105 may include a plurality of disks each on a respective motor, each disk having a white front surface and a black back surface, the motors being driven by a circuit causing the white and black surfaces to be displayed to form a compression resistant pattern. In another example, the projector 110 includes a spatial light modulator (e.g., modulating light from a dedicated source of light or modulating ambient light in the scene).

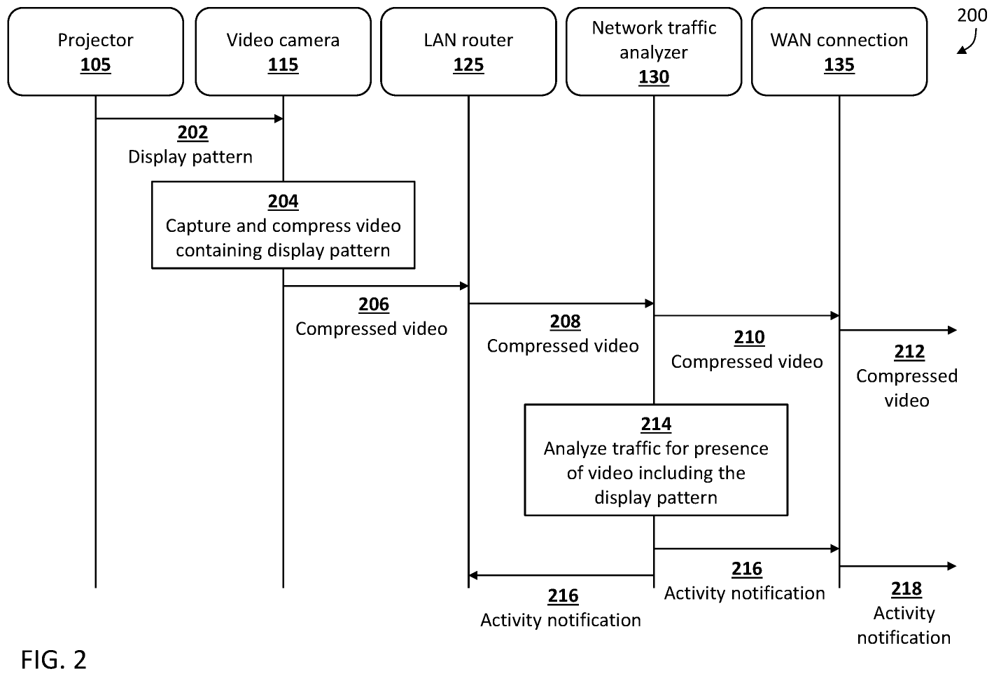

FIG. 2 depicts an example method 200 in which aspects of the present technology may be practiced by a projector 105 and a network traffic analyzer 130. As discussed, in examples, the projector 105 may form, at 202, a display pattern 120 within the field of view of a video camera 115. In examples, operation 202 may comprise causing a projector to form a pattern detectable by a video camera. For example, the network traffic analyzer 130 may send a signal to cause the projector 105 to form the display pattern 120. As discussed, the display pattern 120 may be a pattern projected onto a wall or other surface (e.g., a ceiling or a floor) that is in the field of view of the video camera 115. The display pattern may be formed using infrared light (e.g., by a scanned, modulated infrared laser, or by one or more light-emitting diodes). The display pattern may, in some examples, be formed directly in the field of view of the video camera (e.g., by an array of LEDs that is in the field of view of the video camera). The display pattern may, as discussed, vary with time, e.g., according to a modulation, in a manner that causes the compressed video data rate to be modulated.

The video camera 115 may, at 204, capture the display pattern 120, and form, internal to the camera, a raw video stream of the captured video. The video camera 115 may then compress the raw video to produce compressed video. As discussed, portions of the display pattern 120 may be compression resistant, resulting in a higher data rate in the compressed video when a compression resistant portion is present in the display pattern 120.

The camera may then transmit, at 206, the compressed video to the LAN router 125. The packets transmitted to the LAN router 125 may be addressed to a destination that is external to the LAN, e.g., to a server on the internet.

The LAN router 125 may then retransmit, at 208, the packets out of the WAN connection of the LAN router 125, and the network traffic analyzer 130, which may be configured to operate as a transparent bridge, may receive the packets. Being configured to operate as a transparent bridge, the network traffic analyzer 130 may be configured to retransmit any packet it receives unchanged, so that its presence is hidden from the devices connected to it.

The network traffic analyzer 130 may, accordingly, retransmit, at 210, the compressed video to the WAN connection point 135.

The WAN connection point 135 may then, at 212, retransmit the compressed video to its destination (which, as discussed, may be external to the LAN).

The network traffic analyzer 130 may analyze, at 214, the network traffic passing through it for indications of the presence of video including the display pattern 120. In examples, operation 214 may comprise analyzing a network data rate for network traffic to determine whether the network data rate indicates that the network traffic includes images of the pattern. As discussed, the network traffic analyzer 130 may accomplish this by calculating a correlation between (i) the data rate contribution, as a function of time, that is expected to be included in the total data rate if video data containing the display pattern 120 is transmitted through the network connection and (ii) the rate at which data is transmitted through the network connection (e.g., through the WAN connection of the LAN router 125). A relatively high correlation may indicate that a video camera is currently active, e.g., capturing video containing the display pattern 120, and transmitting the video data through the network connection. For example, the pattern may change at a first point in time, and operation 214 may comprise determining whether the network traffic exhibits a corresponding change in the data rate at the first point in time.

Further, as discussed, if the facility contains a plurality of projectors 105 (one of which is the projector 105 illustrated in FIG. 2), each projector 105 being configured to produce a respective display pattern 120 that when captured as part of a raw video stream causes a respective data rate modulation in compressed video produced from the raw video stream, the respective data rate modulations being independent, the network traffic analyzer 130 may (i) detect whether video containing the display pattern produced by the projector 105 is present in the network traffic, and (ii) detect whether video containing the display pattern produced by any of the other projectors 105 is present in the network traffic.

If the network traffic analyzer 130 determines that a video camera is currently active and capturing video containing the display pattern 120 generated by a projector 105, it may take any of various actions. For example, it may, at 216, transmit an activity notification to the WAN connection point 135 for forwarding to an external destination (e.g., to a server configured to generate an SMS notification to a user). The WAN connection point 135 may then forward, at 218, the activity notification to the external destination (e.g., external monitoring system 145). In other examples, the activity notification may be forwarded, via LAN router 125, to a destination on the LAN. In either event, the recipient of the activity notification may (e.g., manually or programmatically) take a mitigating action. In some examples, the recipient of the notification may send a signal to WAN connection 135 to cause the WAN connection 135 to cease transmitting the video stream. In other examples, one or more alerts may be generated and sent.

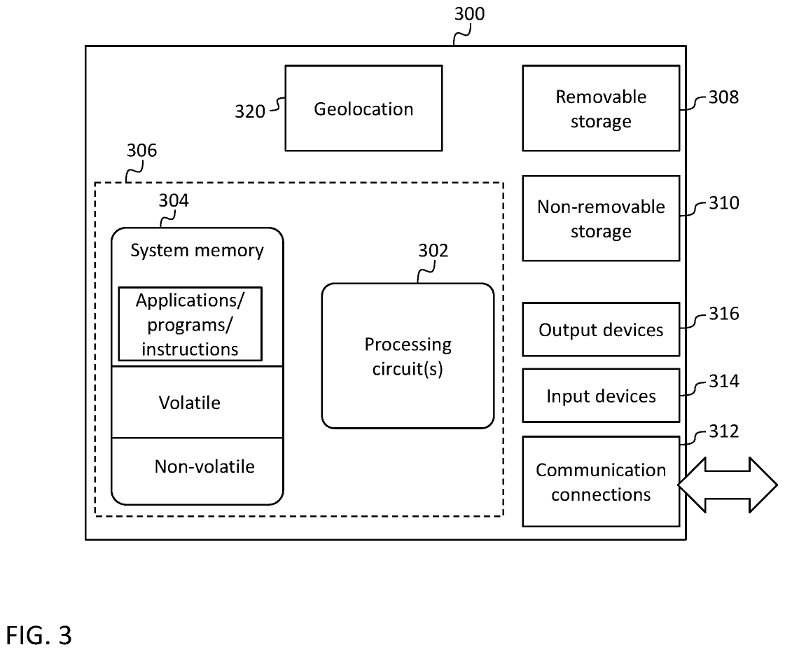

FIG. 3 depicts an example of a suitable operating environment 300, portions of which may be used to implement the projector 105, or the network traffic analyzer 130, or other devices that may include computing functionality within the systems discussed herein. In its most basic configuration, operating environment 300 typically includes at least one processing circuit 302 and memory 304. The processing circuit may be a processor, which is hardware. Depending on the exact configuration and type of computing device, memory 304 (storing instructions to perform the methods disclosed herein) may be volatile (such as RAM), non-volatile (such as ROM, flash memory, etc.), or some combination of the two. This most basic configuration is illustrated in FIG. 3 by dashed line 306. The memory 304 stores instructions that, when executed by the processing circuit(s) 302, perform the processes and operations described herein. Further, environment 300 may also include storage (removable 308, or non-removable 310) including, but not limited to, solid-state, magnetic disks, optical disks, or tape. Similarly, environment 300 may also have input device(s) 314 such as keyboard, mouse, pen, voice input, etc., or output device(s) 316 such as a display, speakers, printer, etc. Additional communication connections 312 may also be included that allow for further communication with LAN, WAN, point-to-point, etc. Operating environment 300 may also include geolocation devices 320, such as a global positioning system (GPS) device.

Operating environment 300 typically includes at least some form of computer readable media. Computer readable media can be any available media that can be accessed by processing circuit 302 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Although exemplary embodiments of systems and methods for improved camera security have been specifically described and illustrated herein, many modifications and variations will be apparent to those skilled in the art. Accordingly, it is to be understood that systems and methods for improved camera security constructed according to principles of this disclosure may be embodied other than as specifically described herein. The invention is also defined in the following claims, and equivalents thereof.

What is claimed is:

1. A system, comprising:
a first projector; and
a network traffic analyzer,
the first projector being configured to form a first pattern within a field of view of a first video camera,
the network traffic analyzer being configured to monitor network traffic in a first network connection, and to determine, based on a data rate of the network traffic, whether video data including images of the first pattern are included in the network traffic.

2. The system of claim 1, wherein the first pattern has a duration of at least one second.

3. The system of claim 1, wherein the first pattern is compression resistant.

4. The system of claim 1, wherein the first projector is configured to cause a first video data rate of the first video camera to be modulated according to a modulation of the first pattern.

5. The system of claim 4, wherein the network traffic analyzer is configured to determine whether the data rate of the network traffic in the first network connection correlates to the modulation.

6. The system of claim 1, wherein the first network connection is a network connection on a wide-area-network side of a router for a facility.

7. The system of claim 1, wherein the first network connection is a network connection on a local-area-network side of a router for a facility.

8. The system of claim 7, wherein:
the network traffic analyzer is further configured to monitor network traffic in a second network connection, and to determine whether video data including images of the first pattern is included in the network traffic of the second network connection.

9. The system of claim 8, wherein the second network connection is a network connection on a wide-area-network side of the router.

10. The system of claim 1, wherein:
the network traffic analyzer comprises a transparent bridge, and
the first network connection is a connection to the transparent bridge.

11. The system of claim 1, wherein:
the first projector comprises an interface for receiving an activation instruction, and
the first projector is configured to transmit the first pattern upon receiving the activation instruction.

12. The system of claim 1, wherein the first projector is configured to transmit the first pattern upon receiving an instruction from the network traffic analyzer.

13. The system of claim 1, further comprising a second projector.

14. The system of claim 13, wherein the second projector is configured to form a second pattern within a field of view of a second video camera.

15. The system of claim 14, wherein:
the first pattern includes a change at a first point in time; and
the second pattern includes a change at a second point in time, different from the first point in time.

16. The system of claim 15, wherein the network traffic analyzer is configured:
to detect a change, at a third point in time, in the data rate of the network traffic; and
to determine:
that the third point in time correlates to the first point in time, and
that the change in the data rate corresponds to the change in the first pattern.

17. A camera detection system, comprising:
a projector, and
a network traffic analyzer,
the camera detection system being configured to detect the presence of an active camera on a network, by:
causing a modification of a scene observed by the camera, and
detecting a change corresponding to the modification in an outgoing data rate of network data.

18. A method, comprising:
causing a projector to form a pattern detectable by a video camera; and
analyzing a network data rate for network traffic to determine whether the network data rate indicates that the network traffic includes images of the pattern.

19. The method of claim 18, wherein the pattern is compression resistant.

20. The method of claim 19, wherein:
the pattern changes at a first point in time, and
the determining whether the network data rate indicates that the network traffic includes images of the pattern comprises determining whether the network traffic exhibits a corresponding change in the data rate at the first point in time.
